(19) United States
(12) Patent Application Publication
(10) Pub. No.: US 2011/0161795 A1
(43) Pub. Date: Jun. 30, 2011

(54) INTER-APPLICATION DOCUMENT ACCESS

(75) Inventors: Thomas A. Bellwood, Austin, TX (US); Robert B. Chumbley, Round Rock, TX (US); Jacob D. Eisinger, Austin, TX (US); Travis M. Grigsby, Austin, TX (US)

(73) Assignee: International Business Machines Corporation, Armonk, NY (US)

(21) Appl. No.: 12/651,044

(22) Filed: Dec. 31, 2009

(51) Int. Cl. G06F 17/00

(52) U.S. Cl. 715/210

(57) ABSTRACT

An operating system can be extended to allow open documents to be automatically transferred from one application to another without saving the open documents. When a request is received to use an open document from a first application in a second application, an open document unit can determine if the open document has not been saved. The open document unit can create a temporary file based on the open document. The open document unit can open the temporary file in the second application. In addition, the open document unit can convert the temporary file into a format compatible with the second application if the temporary file's format is not compatible with the second application.

### BACKGROUND

Embodiments of the inventive subject matter generally relate to the field of computer applications, and, more particularly, to inter-application document accessing.

After creating a document in one application, a user may wish to immediately use the document in another application. For example, the user wishes to upload a Hypertext Markup Language (HTML) file created in a text editor to the web using a File Transfer Protocol (FTP) application. As another example, the user wishes to attach a Report created in a word processor to an email. To use the document in another application, the user saves the document in a first application to a file on a file system. To open the file in a second application, the user then evokes an “open” menu in the second application to browse the file system and select the file.

### SUMMARY

Embodiments include a method directed to determining a plurality of open documents that are accessible, through user interfaces of a plurality of applications, for operations that comprise editing and viewing. Determining that a first of the plurality of documents, already open in a first of the plurality of applications, should be opened in a target application. A file can created based on the first of the plurality of documents. The file can be opened in the target application.

Embodiments include a computer program product comprising a computer usable medium having computer usable program code. The computer usable program code being configured to determine a plurality of open documents that are accessible, through user interfaces of a plurality of applications, for operations that comprise editing and viewing. Determining that a first of the plurality of documents, already open in a first of the plurality of applications, should be opened in a target application. If the first of the plurality of documents has not been saved in the first of the plurality of applications, a file can created based on the first of the plurality of documents. The file can be opened in the target application.

Embodiments include an apparatus comprising one or more processing units, a network interface and an open document unit. In some embodiments, the open document unit can be operable to determine a plurality of open documents that are accessible, through user interfaces of a plurality of applications, for operations that comprise editing and viewing. Determining that a first of the plurality of documents, already open in a first of the plurality of applications, should be opened in a target application. If the first of the plurality of documents has not been saved in the first of the plurality of applications, a file can created based on the first of the plurality of documents. The file can be opened in the target application.

### BRIEF DESCRIPTION OF THE DRAWINGS

The present embodiments may be better understood, and numerous objects, features, and advantages made apparent to those skilled in the art by referencing the accompanying drawings.

FIG. 1 is an example conceptual diagram of allowing an application to access a document open in another application.

FIG. 2 depicts a flowchart of example operations for allowing an application to access documents open in other applications.

FIG. 3 depicts a flow chart of example operations for displaying a representation of an open document.

FIG. 4 depicts an example computer system.

### DESCRIPTION OF EMBODIMENT(S)

The description that follows includes exemplary systems, methods, techniques, instruction sequences, and computer program products that embody techniques of the present inventive subject matter. However, it is understood that the described embodiments may be practiced without these specific details. For instance, although examples refer to word processors, embodiments may utilize other types of applications such as text editors, spreadsheet applications, FTP applications, presentation applications, etc. In other instances, well-known instruction instances, protocols, structures, and techniques have not been shown in detail in order not to obfuscate the description.

Files recently created in one application are frequently used in other applications. It can be cumbersome to save a file in a first application, open a second application, and browse to the file so that the file can be used in the second application. An operating system can be extended to allow open documents to be automatically transferred from one application to another without saving the open documents. When a request is received to use an open document from a first application in a second application, an open document unit can determine if the open document has not been saved. The open document unit can create a temporary file based on the open document. The open document unit can open the temporary file in the second application. In addition, the open document unit can convert the temporary file into a format compatible with the second application if the temporary file's format is not compatible with the second application. Alternatively, the open document unit can create the temporary file in a format that is compatible to the second application.

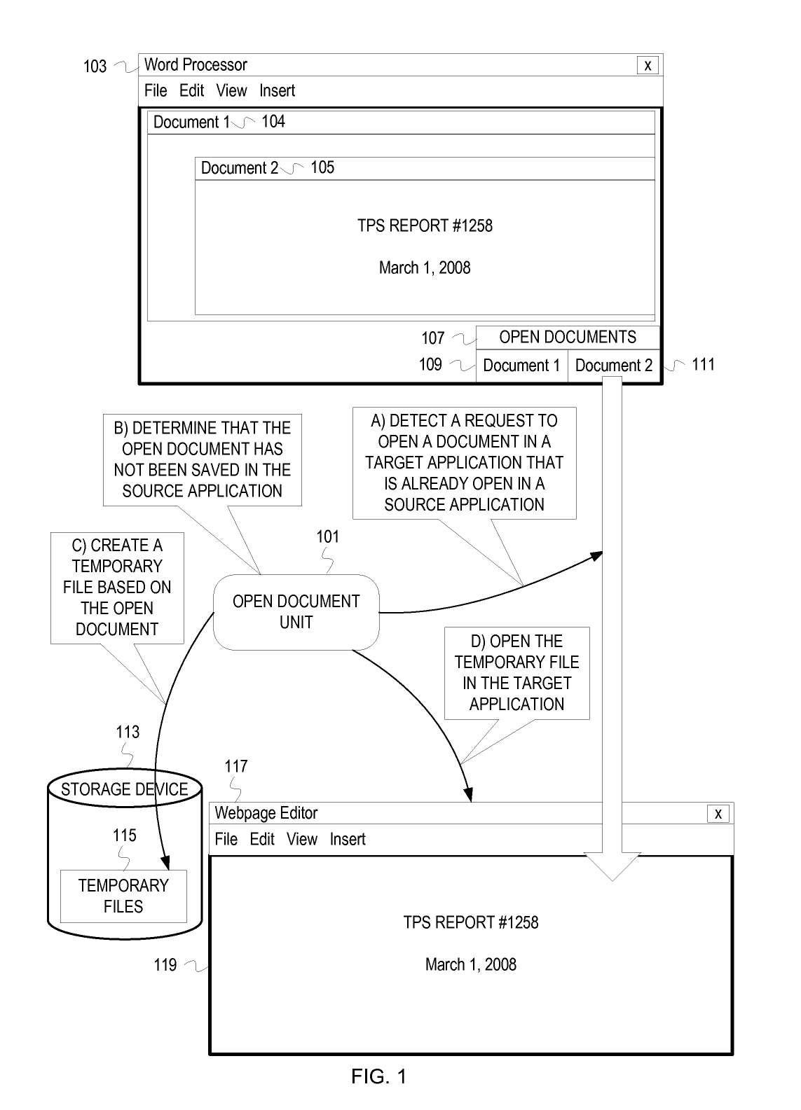

FIG. 1 is an example conceptual diagram of allowing an application to access a document open in another application. Two documents, “Document 1” 104 and “Document 2” 105, are open in a word processor 103. An “open” document is accessible through a user interface for various operations, such as editing, reading, converting, etc. The “Document 1” 104 and the “Document 2” 105 have not been saved. A list of open documents 107 is displayed in the word processor 103 window. The list of open documents comprises “Document 1” item 109 and “Document 2” item 111. The “Document 1” item 109 corresponds to the “Document 1” 104, and the “Document 2” item 111 corresponds to the “Document 2” 105.

At stage A, an open document unit 101 detects a request to open the document 105, which is already open in a source application 103, in a target application 117 because a user wishes to create a webpage from the open document 105. The open document unit 101 can be a third-party program, an add-on to the applications 103 and 107, integrated into an operating system, etc. The open document unit 101 determines the open documents 104 and 105 based on notifications from the word processor 103. For example, the word processor 103 sends notifications to the open document unit 101 when the open documents 104 and 105 are created. The word processor 103 can also send notifications to the open document unit 101 when an existing file is opened. The open document unit 101 can also determine the open documents by examining a file descriptor. For example, the open document unit 101 can utilize attributes associated with entries in the file descriptor to determine the open documents 104 and 105. The attributes can comprise an entry type, an application identifier, a document type, a document status (e.g., saved, not saved, etc.), etc. The open document unit 101 can display indications of the open documents 104 and 105. In this example, the open document unit displays icons, “Document 1” item 109 and the “Document 2” item 111, corresponding to the open documents 104 and 105. The “Document 1” item 109 and the “Document 2” item 111 can be dragged from the source application, word processor 103, to the target application, webpage editor 117, to cause the corresponding open document to be opened in the target application 117. The open document unit 101 detects that the “Document 2” item 111 has been dragged from the source application, the word processor 103, into a window of the target application, webpage editor 117. As another example, the “Document 1” item 109 and the “Document 2” item 111 can represent buttons. When the buttons are clicked, a menu listing available target applications can pop up so that a target application can be chosen. The open document unit 101 can detect that the webpage editor 117 was chosen from the menu.

At stage B, the open document unit 101 determines that the open document has not been saved in the source application 103. For example, the open document unit 101 determines that the “Document 2” 105 has not been saved in the word processor 103 because the “Document 2” 105 has a temporary name. As another example, the open document unit 101 determines that the open document 105 differs from the last saved version of the open document 105.

At stage C, the open document unit 101 creates a temporary file based on the open document 105. Creating the temporary file can comprise retrieving document data from memory and storing the temporary file containing the document data in a location in a computer's file system. In this example, the open document unit 101 stores the temporary file in temporary files 115 on a storage device 113. The open document unit 101 can record a reference to the location of the temporary file on the storage device 113.

At stage D, the open document unit 101 opens the temporary file in the target application 117. In this example, the open document unit 101 utilizes the reference to the location of the temporary file to open the temporary file in the webpage editor 117. The temporary file opened in the webpage editor 117 represents a third open document 119. The temporary file can be completely independent of the “Document 2” 105 because the “Document 2” 105 was not saved in the word processor 103. So, the “Document 2” 105 and the temporary file can be edited independently. In this example, changes made to the open document 119 do not affect the open document 105.

Although examples refer to a list of open documents displayed in an application window, embodiments are not so limited. For example, a list of open documents can be displayed on an operating system taskbar. As another example, a list of open documents can be displayed in a drop down menu of an application.

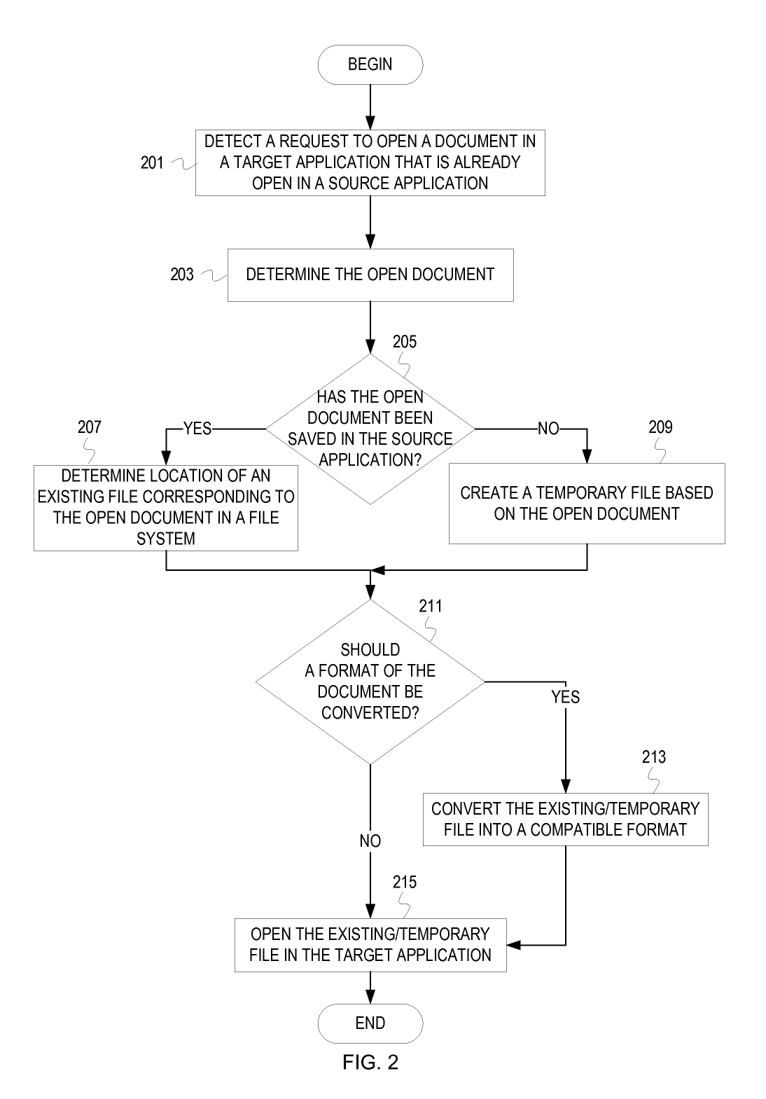

FIG. 2 depicts a flowchart of example operations for allowing an application to access documents open in other applications. A request to open a document in a target application is detected (block 201). The document is already open in a source application. For example, a list of open documents may be displayed in a drop-down menu of the target application. A click on one of the open documents can be detected. As another example, an open document unit can detect that an “open documents’ icon was dragged from a taskbar into the target application.

The open document is determined (block 203). The open document can be determined automatically. For example, an icon is dragged and dropped into the target application. The open document associated with the icon can be determined. The open document can be determined manually. For example, the open document can be determined by prompting a user to select the open document from a list of open documents.

It is determined if the document has been saved in the source application (block 205).

If the document has been saved, a location of an existing file corresponding to the open document in the file system is determined (block 207). For example, the location is determined based on a file system reference from the source application.

If the document has not been saved, a temporary file is created based on the open document (block 209). Creating the temporary file can comprise accessing document data in memory, storing the document data in a location of a file system, and recording a reference to the location. For example, an open document unit determines a name for a file based on text in the document and saves the file in a temporary folder. In addition, a user can be prompted to save the open document if user preferences indicate a user's desire to save files before using open documents in another application. If preferences indicate a desire to save the open document, the user can be prompted to specify a file system location and a file name for the open document.

After the existing file is located or a temporary file is created, it is determined if a format of the open document should be converted (block 211). The format may be converted if the format is not compatible with the target application. For example, a user may wish to use an open computer aided drafting (CAD) document in a presentation. The CAD application stores a representation of the CAD document in format that is not readable by a presentation application. To use the CAD document in the presentation application, the CAD document is converted to an image, in this example, so that it can be recognized by the presentation application. The format may be converted if user preferences indicate that the document should be converted to a different format. For example, preferences may indicate that CAD documents be converted to images when a CAD document currently open in a CAD application is used in an e-mail application.

If the format should be converted, the existing/temporary file is converted into a compatible format (block 213). For example, an open CAD document is converted to an image so that the CAD document can be viewed in an e-mail application. Converting the existing/temporary file into a compatible format can comprise determining the compatible format based on an indication by a target application. The target application can specify compatible formats to an open document unit (e.g., in metadata, in application attributes, etc.). The existing/temporary file can be saved in a compatible file type and a file system reference to a compatible file can be recorded. The file system reference can be passed to the target application so the compatible file can be opened.

The existing/temporary file is opened in the target application (block 215). Opening the existing/temporary file in the target application is based on the file system reference that indicates a location of the existing/temporary file in a file system. For example, an open document unit evokes the target application's open command with the file system reference.

Although examples refer to converting a temporary file into a format compatible with a target application, embodiments are not so limited. For example, an appropriate format can be determined prior to creating a temporary file so that the temporary file can be created in the appropriate format.

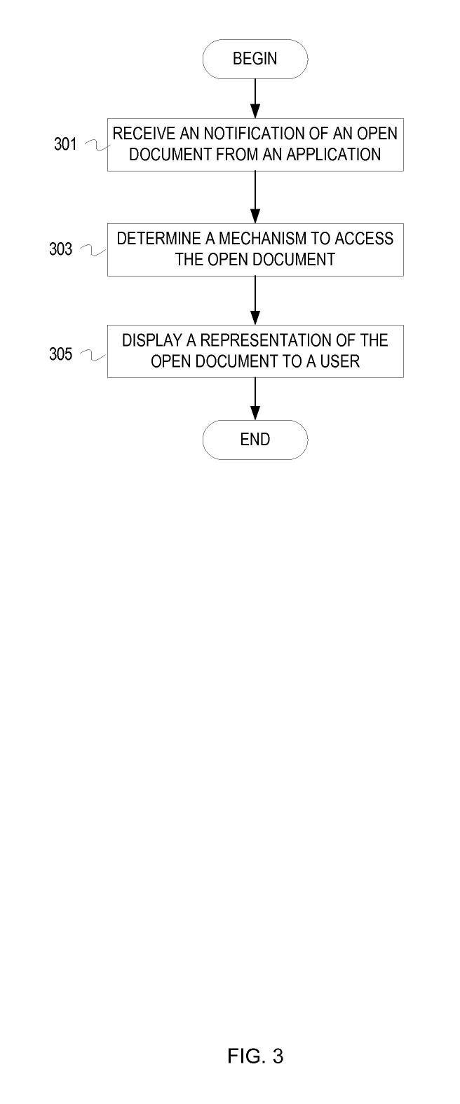

To allow a user to specify open documents to be used in a target application, a representation of the open documents is presented to the user. The user can select an open document from the representation so that the open document can be opened in the target application. The open document unit can determine the open documents before displaying the representation. For example, source applications can notify the open document unit of the source applications' open documents. FIG. 3 depicts a flow chart of example operations for displaying a representation of an open document. A notification of an open document is received from an application (block 301). For example, an application sends a notification when a new document is created in the application. As another example, the application sends the notification when an existing document is opened in the application.

A mechanism to access the open document is determined (block 303). For example, the open document unit queries the application for the mechanism. As another example, the open document unit determines the mechanism from the notification of open documents. As another example, the open document unit determines the mechanism based on previously stored data. Example mechanisms include an application function call that makes document data available to an open document unit, a reference to document data in memory, or both. An open document unit uses the mechanism to access the open document so that it can be opened in a target application. For example, the open document unit receives a memory reference to document data for a document that has not been saved. The open document unit retrieves the document data and creates a temporary file based on the document data. The open document unit opens the temporary file in a target application based on a file system reference to the temporary file. The mechanism may be different for temporary documents and existing documents. For example, temporary documents may be accessed by a function call while existing documents may be accessed based on a file system reference.

A representation of the open document is displayed to a user (block 305). For example, a link to the open document can be displayed on the task bar. As another example, the open document can be displayed in drop down menus of running applications. The representation can contain text to help the user identify the open document. For example, a file name can be displayed if the open document has been saved. As another example, an excerpt of document text can be displayed if the open document has not been saved. As another example, a document type, a created date, a file size, etc. can be displayed for documents that do not contain text (e.g., images, videos, etc.).

Although examples refer to receiving notifications of open documents from applications, embodiments are not so limited. For example, an open document unit can automatically determine open files based on a system's file descriptor. The file descriptor can refer to files, directories, sockets, etc. So, the open document unit utilizes attributes associated with each entry in the file descriptor to determine if the entry is an open document.

Embodiments may take the form of an entirely hardware embodiment, a software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible medium of expression having computer usable program code embodied in the medium. The described embodiments may be provided as a computer program product, or software, that may include a machine-readable medium having stored thereon instructions, which may be used to program a computer system (or other electronic device(s)) to perform a process according to embodiments, whether presently described or not, since every conceivable variation is not enumerated herein. A machine-readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

Computer program code for carrying out operations of the embodiments may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (for example, through the Internet using an Internet Service Provider).

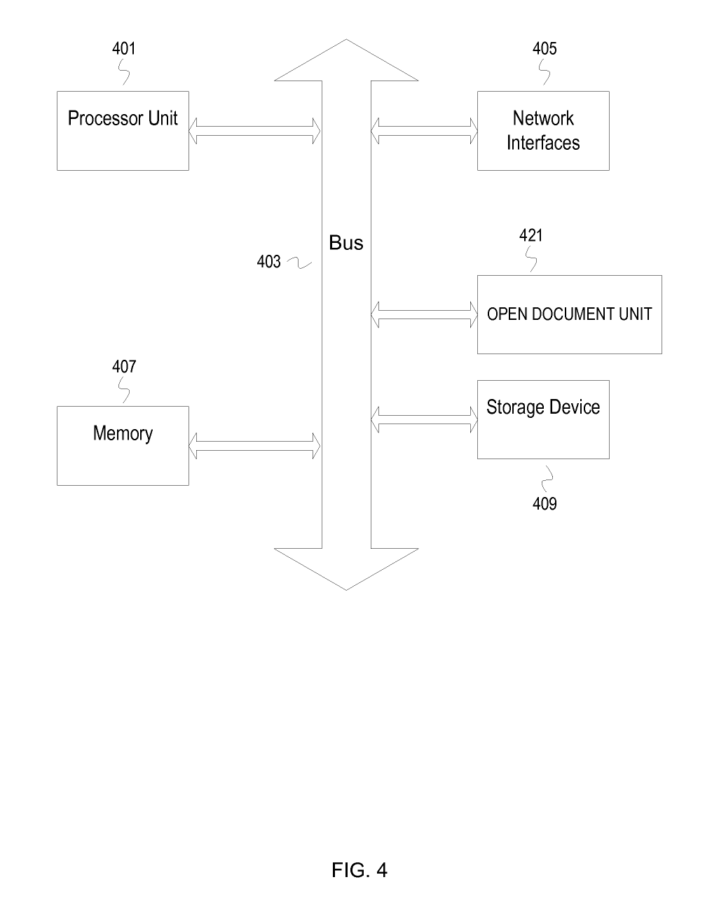

FIG. 4 depicts an example computer system. A computer system includes a processor unit 401 (possibly including multiple processors, multiple cores, multiple nodes, and/or implementing multi-threading, etc.). The computer system includes memory 407. The memory 407 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 403 (e.g., PCI, ISA, PCI-Express, HyperTransport®, InfiniBand®, NuBus, etc.), a network interface 405 (e.g., an ATM interface, an Ethernet interface, a Frame Relay interface, SONET interface, wireless interface, etc.), and a storage device(s) 409 (e.g., optical storage, magnetic storage, etc.). The computer system also includes an open document unit 421. In response to a request to open a document, which is already open in a source application, in a target application, the open document unit 421 can determine if the open document has been saved. If the document has been saved, the open document unit 421 can create a temporary file based on the open document. The open document unit 421 can then open the temporary file in the target application. If the document has been saved, the open document unit 421 determines an existing file corresponding to the open document and opens the existing file in the target application. Any one of these functionalities may be partially (or entirely) implemented in hardware and/or on the processing unit 401. For example, the functionality may be implemented with an application specific integrated circuit, in logic implemented in the processing unit 401, in a co-processor on a peripheral device or card, etc. Further, realizations may include fewer or additional components not illustrated in FIG. 4 (e.g., video cards, audio cards, additional network interfaces, peripheral devices, etc.). The processor unit 401, the storage device(s) 409, and the network interface 405 are coupled to the bus 403. Although illustrated as being coupled to the bus 403, the memory 407 may be coupled to the processor unit 401.

While the embodiments are described with reference to various implementations and exploitations, it will be understood that these embodiments are illustrative and that the scope of the inventive subject matter is not limited to them. In general, techniques for inter-application document access as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
determining a plurality of open documents, wherein the plurality of open documents are accessible, through user interfaces of a plurality of applications, for operations that comprise at least one of editing and viewing;
determining that a first of the plurality of open documents, already open in a first of the plurality of applications, should be opened in a target application;
creating a file based on the first of the plurality of documents; and
opening the file in the target application.

2. The method of claim 1, wherein said determining the plurality of open documents comprises, at least one of, receiving notifications from the plurality of applications indicating the plurality of open documents, and determining the plurality of open documents based on file descriptors thereof.

3. The method of claim 1, wherein said determining that the first of the plurality of open documents, already open in the first of the plurality of applications, should be opened in the target application comprises:
displaying a representation of the plurality of open documents, wherein the representation comprises, at least one of, a group of icons representing the plurality of open documents and a list representing the plurality of open documents; and
detecting, at least one of, a click on an item in the representation corresponding to the first of the plurality of documents, and movement of the item into a user interface of the target application.

4. The method of claim 1, wherein said creating the file based on the first of the plurality of open documents comprises:
retrieving document data for the first of the plurality of open documents from memory;
creating the file with the document data at a location in a file system; and
recording a reference to the location in the file system.

5. The method of claim 1 further comprising:
determining that a second of the plurality of open documents, already open in the first of the plurality of applications, should be opened in the target application;
determining that the second of the plurality of open documents has been saved in the first of the plurality of applications;
determining a reference indicating a file system location of an existing file corresponding to a saved version of the second of the plurality of open documents; and
opening the existing file in the target application based on the reference.

6. The method of claim 5 further comprising:
determining that the second of the plurality of open documents differs from the existing file; and
saving changes to the existing file.

7. The method of claim 1 further comprising:
determining that a format of an the existing file is incompatible with the target application, wherein the existing file corresponds to the open document; and
generating from the existing file a converted file in a format compatible with the target application.

8. A computer program product for inter-application document access, the computer program product comprising:
a computer usable medium having computer usable program code embodied therewith, the computer usable program code comprising:
computer usable program code configured to,
determining a plurality of open documents, wherein the plurality of open documents are accessible, through user interfaces of a plurality of applications, for operations that comprise at least one of editing and viewing;
determining that a first of the plurality of open documents, already open in a first of the plurality of applications, should be opened in a target application;
determining that the first of the plurality of open documents has not been saved in the first of the plurality of applications;
creating a file based on the first of the plurality of documents; and
opening the file in the target application.

9. The computer program product of claim 8, wherein the computer useable program code being configured to determine the plurality of open documents comprises the computer useable program code being configured to, at least one of, receive notifications from the plurality of applications indicating the plurality of open documents, and determine the plurality of open documents based on file descriptors thereof.

10. The computer program product of claim 8, wherein the computer useable program code being configured to determine that the first of the plurality of open documents, already open in the first of the plurality of applications, should be opened in the target application comprises the computer useable program code being configured to:
display a representation of the plurality of open documents, wherein the representation comprises, at least one of, a group of icons representing the plurality of open documents and a list representing the plurality of open documents; and
detect, at least one of, a click on an item in the representation corresponding to the first of the plurality of documents, and movement of the item into a user interface of the target application.

11. The computer program product of claim 8, wherein the computer useable program code being configured to create the file based on the first of the plurality of open documents comprises the computer useable program code being configured to:
retrieve document data for the first of the plurality of open documents from memory;
create the file with the document data at a location in a file system; and
record a reference to the location in the file system.

12. The computer program product of claim 8, wherein the computer useable program code being further configured to:
determine that a second of the plurality of open documents, already open in the first of the plurality of applications, should be opened in the target application;
determine that the second of the plurality of open documents has been saved in the first of the plurality of applications;
determine a reference indicating a file system location of an existing file corresponding to a saved version of the second of the plurality of open documents; and
open the existing file in the target application based on the reference.

13. The computer program product of claim 12 comprises the computer useable program code being further configured to:
determine that the second of the plurality of open documents differs from the existing file; and
save changes to the existing file.

14. The computer program product of claim 8 comprises the computer useable program code being further configured to:
determine that a format of an existing file is incompatible with the target application, wherein the existing file corresponds to the open document; and
generate from the existing file a converted file in a format compatible with the target application.

15. An apparatus comprising:
one or more processing units;
a network interface; and
an open document unit operable to,
determine a plurality of open documents, wherein the plurality of open documents are accessible, through user interfaces of a plurality of applications, for operations that comprise at least one of editing and viewing;
determine that a first of the plurality of open documents, already open in a first of the plurality of applications, should be opened in a target application;
determine that the first of the plurality of open documents has not been saved in the first of the plurality of applications;
create a file based on the first of the plurality of documents; and
open the file in the target application.

16. The apparatus of claim 15, wherein the open document unit being operable to determine the plurality of open documents comprises the open document being configured to, at least one of, receive notifications from the plurality of applications indicating the plurality of open documents, and determine the plurality of open documents based on file descriptors thereof.

17. The apparatus of claim 15, wherein the open document unit being operable to create the temporary file based on the first of the plurality of open documents comprises the open document unit being configured to:
retrieve document data for the first of the plurality of open documents from memory;
create the file with the document data at a location in a file system; and
record a reference to the location in the file system.

18. The apparatus of claim 15 comprises the open document unit being further operable to:
determine that a second of the plurality of open documents, already open in the first of the plurality of applications, should be opened in the target application;
determine that the second of the plurality of open documents has been saved in the first of the plurality of applications;
determine a reference indicating a file system location of an existing file corresponding to a saved version of the second of the plurality of open documents; and
open the existing file in the target application based on the reference.

19. The apparatus of claim 18 comprises the open document unit being further operable to:
determine that the second of the plurality of open documents differs from the existing file; and
save changes to the existing file.

20. The apparatus of claim 15 comprises the open document unit being further operable to:
determine that a format of an existing file for the open document is incompatible with the target application; and
generate from the existing file a converted file in a format compatible with the target application.
